(19) United States
(12) Patent Application Publication
(10) Pub. No.: US 2012/0207879 A1
(43) Pub. Date: Aug. 16, 2012

(54) Quick Dry Process for Drying Meat

(76) Inventor: Jerome D. Leising, Shorewood, MN (US)

(21) Appl. No.: 13/351,013

(22) Filed: Jan. 16, 2012

Related U.S. Application Data
(60) Provisional application No. 61/443,306, filed on Feb. 16, 2011.

(51) Int. Cl. A23L 1/317; A23B 4/03

(52) U.S. Cl. 426/59; 426/646; 426/438

(57) ABSTRACT

Semi-dry or dry sausage, and method of preparing semi-dry or dry sausage, including removing moisture from cooked and diced or sliced meat using hot oil. The semi-dry or dry sausage may be prepared by mixing raw ground meat and seasoning, extruding the seasoned ground meat, cooking the extruded meat, dicing or slicing the extruded meat, and immersing the cooked diced or sliced meat in oil at a time and temperature sufficient to remove moisture from the cooked meat to form a semi-dry or dry sausage. The time and temperature can be selected to achieve a desired moisture to protein ratio in the sausage.

### CROSS-REFERENCE TO RELATED APPLICATIONS

This application claims the benefit of priority under 35 U.S.C. 119(e)(1) of a provisional patent application Ser. No. 61/443,306, filed Feb. 16, 2011, which is incorporated herein by reference in its entity.

### BACKGROUND

Traditionally, the preparation of dry meats such as pepperoni and other semi-dry and dry sausages involves a multi-step process, culminating in a lengthy drying process during which time the meat is dried and cured. As a result, it may take from 12 to 60 days to prepare a dried cured meat, making such products costly to prepare.

The process for making dry and semi-dry sausage products typically includes adding and mixing (admixing) ground meat (pork, beef and/or poultry) with spices, curing agents and either an acid producing bacteria or an acidulant. The types of meat, spices, and curing agent employed depend upon the type of sausage product desired. Next the meat mixture is formed into the desired shape by stuffing the mixture into casings which may be either prepared animal intestines or manufactured casings such as fibrous casings, which are then tied shut at both ends to form a single cylindrical unit, or tied at intervals to form links. The mixture must be pre-formed into the tubular shape before fermentation or acidification, either by the action of bacteria or the addition of acid to the admixture.

In products which include bacteria for acidification, a fermentation period is required for sufficient bacterial activity to occur. During the fermentation period, the formed products are allowed to set in a fermenting chamber at a predetermined temperature and humidity for a period of time sufficient for enough acid to be produced by the bacteria to lower the pH of the admixture to a value below 5.2, and such as 4.6-5.0. During fermentation, the bacteria use carbohydrates such as dextrose to produce lactic acid, which gives the sausage its characteristic flavor. The lactic acid also serves to lower the pH of the meat proteins toward their isoelectric point. This is particularly desirable because the meat proteins are less able to bind moisture as they approach their isoelectric point, thereby facilitating subsequent drying of the sausage. The low pH level prevents further bacterial growth and otherwise makes the product biologically stable, produces an acidic flavor and sets the protein structure in the meat thereby giving the product a firm texture. The temperature in the fermentation chamber is typically maintained between 60° F. and 110° F. for about 7 to 14 hours.

In products which use an acidulant for decreasing the pH of the product, prolonged fermentation is not required. Rather acids are added directly to the meat mixture, which facilitates the reduction of pH of the meat product.

While traditional processes did not employ cooking but rather relied upon acidification to cure the meat, in modern processes, after fermentation or acidification, the product is typically cooked. For example, cooking pepperoni style products to an internal temperature of 128° F. and holding at that temperature for 60 minutes is a typical heating requirement in order to ensure pathogen reduction and safety of the product.

Finally, both bacteria fermented and acidulant containing products must be dried. Drying is performed at a predetermined temperature and for a period of time to obtain the desired finished product moisture to protein ratio (e.g., for pepperoni, 1.6:1). For dry sausage products, the drying step must be carried out under conditions which allow slow controlled uniform removal of moisture from the product yet inhibit the growth of surface mold or yeast. For example, the drying chamber is typically maintained at a temperature between 50° F. and 70° F. and kept relatively dry to inhibit the growth of mold or yeast. It generally requires several days or even weeks to reach the required finished product moisture to protein ratio, depending upon the thickness of the formed product and other process conditions. Furthermore, the drying process is usually gradual to avoid changes in the chemical or textural properties of the meat. For some sausage, such as pepperoni, the drying may take between 12 to 14 days. Other sausages, such as salami, may require 4 to 6 weeks for drying. Because the sausages must be kept in the controlled drying environment for an extended period of time, this drying step adds significant cost to the production of dry and semi dry sausages.

Dry and semi-dry sausage products are classified by the United States Department of Agriculture (“USDA”) according to process conditions, finished product pH, finished product moisture to protein ratio, and other factors. For example, in order to meet the USDA requirements for pepperoni, the product must have a finished product moisture to protein ratio of 1.6 to 1 and be processed under conditions specified by the USDA as sufficient to kill trichinae. In order to meet the regulatory definition for beef summer sausage, the product must have a finished product moisture to protein ratio of 3.1 to 1 and a finished product pH of no greater than 5.

Likewise, other dried meats, such as beef jerky or other meat jerky, dried shredded beef, and bacon bits require drying steps. As with dry and semi-dry sausage, this drying step must typically be performed under conditions of controlled temperature and humidity for an extended period of time, adding cost to the production process.

Maintenance of the required conditions during the extended fermenting and drying steps can make mass production of dried meat such as dry and semi-dry sausage products somewhat difficult and costly. There is a need for an economical process for making dry and semi-dry sausage products and dried meats in a shorter period of time.

### SUMMARY

Embodiments of the invention include methods of preparing a semi-dry or dry sausage including mixing raw ground meat and seasoning to form seasoned ground meat, extruding the seasoned ground meat into a formed shape or into a casing, cooking the extruded meat, dicing or slicing the extruded meat, immersing the cooked diced or sliced meat in oil at a time and temperature sufficient to remove moisture from the cooked meat to form a semi-dry or dry sausage, removing the dried sausage from the oil. The step of immersing the cooked meat in oil can be performed at a temperature of between about 200 and about 300 degrees Fahrenheit, for example, and can be performed using a thermal screw. Immersing the cooked meat in oil can dry the meat to a moisture to protein ratio of approximately 1.6 to 1, or to a moisture to protein ratio of less than 1.6 to 1. The step of slicing or dicing the cooked meat can be performed prior to immersing it in oil. The method can be used to prepare pepperoni, for example.

In some embodiments, the method further includes fermenting the extruded meat prior to cooking the meat. In other embodiments, the ground meat is combined with an acidulant.

The time of immersion of the meat in the oil and the temperature of the oil depends, among other things, upon the desired amount of drying of the meat. In some embodiments, the meat is immersed in the oil for less than 4 minutes. In other embodiments, the cooked meat is immersed in the oil for less than 1 minute. In still other embodiments, the cooked meat is immersed in the oil for less than 30 seconds. In some embodiments, the step of immersing the cooked meat in oil is performed at a temperature of between about 200 and about 250 degrees Fahrenheit.

Embodiments of the invention also include methods of reducing the drying time of a cooked semi-dry or dry sausage including cutting cooked sausage into pieces having a reduced size, transferring the cut cooked sausage into a trough of thermal screw containing oil at a temperature between about 200 and about 300 degrees Fahrenheit, passing the cut sausage through the trough to dry the cut sausage, and removing the dried sausage from the heated oil. The step of cutting the cooked sausage can include slicing or dicing. In some embodiments, the dried sausage can have a moisture to protein ratio of approximately 1.6 to 1, or can have a moisture to protein ratio of less than 1.6 to 1. In some embodiments, the step of passing the cut sausage through the trough to dry the cut sausage is performed for less than about 4 minutes, such as less than 1 minute or less than 30 seconds.

Embodiments of the invention also include methods of improving the yield of semi-dry or dry sausage after drying. In some embodiments, the method of improving the yield of semi-dry or dry sausage after drying includes cutting cooked sausage having a first weight into pieces having a reduced size, transferring the cut cooked sausage into heated oil at a temperature between 200 and 300 degrees Fahrenheit, immersing the cooked sausage in the heated oil for a period of time sufficient to dry the sausage to a moisture to protein ratio of 1.6 to 1 or less, and removing the dried sausage from the heated oil. The dried sausage has a second weight which is less than the first weight. For example, the ratio of the second weight to the first weight can be about 60 to about 76 percent. The step of cutting can include slicing or dicing. The dried sausage can have a moisture to protein ratio of approximately 1.6 to 1, or it can have a moisture to protein ratio of less than 1.6 to 1. In some embodiments, the step of passing the cut sausage through the trough to dry the cut sausage is performed for less than 4 minutes, while in other embodiments it is performed for less than 1 minute, and in still other embodiments it is performed for less than 30 seconds.

### BRIEF DESCRIPTION OF THE DRAWINGS

FIG. 1 is a flow diagram of a process for preparing dry or semi dry sausage according to embodiments of the invention; and

FIG. 2 is a diagram of a thermal screw which may be used in embodiments of the invention.

### DETAILED DESCRIPTION OF THE INVENTION

Embodiments of the invention provide a method of quickly drying meat products, such as sausage products, to meet the USDA standards for semi dry and dry sausage products and dry meat products. After the meat product has been prepared into a solid format and cooked, the meat can be diced or sliced and then dried by removing the moisture using a hot oil bath at temperatures below that of traditional frying. In some embodiments, the drying process comprises passing the diced or sliced meat through a thermal screw to remove moisture. In this way, moisture is quickly removed from the meat. Temperature is controlled to insure that fat blended in with the meat is not melted out and lost during the drying step. In addition to being quicker than other (e.g. prior) methods, embodiments of the invention can result in an improved product yield. Embodiments of the invention therefore allow for more efficient and less expensive production of any meat such as dry and semi-dry sausage due to the reduction in preparation time as well as the improved product yield.

Dry and semi-dry sausage must conform to USDA standards relating to processing conditions and final product criteria, such as pH and moisture to protein ratio. For example, semi-dry sausage must have a moisture to protein ratio of 1.6:1 or less. Some products have a higher moisture to protein ratio limits, such as beef summer sausage (3.1:1), thuringer (3.7:1), dry salami (1.9:1), dry sausage (1.9:1), genoa salami (2.3:1), and farmer summer sausage (1.9:1). Other products are drier, having a lower moisture to protein ratio limit, such as jerky (0.75:1). The oil heating process according to embodiments of the invention may therefore be used to reduce the moisture content of the dry and semi-dry sausages and other dried meats to the USDA required levels, including those listed above.

Embodiments of the invention reduce the moisture content of the meat product by heating, the meat in oil. In some embodiments, this may be done using an oil bath. Examples of oil baths which may be used in embodiments of the invention include, but are not, limited to, batch jacket kettles and fryers. In other embodiments, the process is continuous. For example, the meat may be dried using thermal screw, which conveys the meat along a trough while heating the meat in hot oil.

The temperature of the oil and the heating time are selected as required for removing the desired amount of moisture. Longer times and/or higher temperatures may be used for achieving lower final moisture levels. Furthermore, when a higher (e.g. hotter) temperature is used, a shorter heating time is required for any amount of moisture removal. Likewise, when a lower temperature is used, a longer heating time is required. As such, it can be appreciated that the required heating time and the oil temperature are generally inversely related.

In some embodiments, the type of machine used for heating the meat in the oil will determine the amount of time in which the meat will be in direct contact with the oil for drying. For example, when a continuous thermal screw is used, the meat enters in one end of the machine, and is conveyed through the trough using a screw auger to insure a first in first out at the exit at the opposite end. The transit time through the thermal screw is therefore determined by the length of the trough and the speed of rotation of the thermal screw. As such, the transit time of the meat through the thermal screw will depend upon the physical parameters of the thermal screw. In general, the transit time through standard existing thermal screws is between about 2.5 and about 8 minutes, and in some embodiments is from about 2.5 to about 5 minutes. The temperature for the oil can therefore be selected to achieve the desired reduction in moisture based on the amount of time the meat will be present in the oil. For example, the oil may be at approximately 200° F. to about 230° F. for diced or sliced pepperoni product in such thermal screws to achieve a moisture to protein ratio of 1.6 to 1.

As discussed above, the choice of temperature will depend upon the desired dryness of the final product and the amount of time it is exposed to the oil, with higher temperatures requiring shorter oil immersion times. However, in some embodiments, it is desirable for the temperature of the oil to be less than about 200° F., so that the fat in the meat is not completely melted and lost during the drying process. In some embodiments, the oil temperature may be from about 200° F. to about 280° F. In other embodiments, the oil temperature may be from about 210° F. to about 230° F.

As discussed above, when the meat is dried using a standard thermal screw, the transit time may be about two and a half to about five minutes. Given this timing, the temperature of the oil may be set to achieve the desired moisture level. For example, in order to achieve a moisture to protein ratio of 1.6:1 as required for semi dry meat such as pepperoni, the oil temperature may be about 200° F.-230° F. For a moisture to protein ratio of 1.9:1, as required for dry sausage, the oil temperature may be lower, such as about 180° F. to about 185° F. For meat products such as beef jerky or bacon bits, having a moisture to protein ratio of 0.75:1, the oil temperature may be higher, such as about 340° F. to about 350° F. Of course, different thermal screws may have different transit times. In addition, the thermal screws may be modified, such as by shortening the length of the trough, thereby decreasing the transit time. In such cases, the cooking temperature may be adjusted appropriately so that the desired moisture to protein ratio is achieved. For example, if a quicker drying time is desired, the thermal screw may be shortened and the oil temperature may be increased. For example, a temperature of about 280° F. to about 300° F. may be used for about 10 to 20 seconds to obtain a moisture to protein ratio of about 1.6 to 1. However, it may be desirable to limit the temperature of the oil to temperatures at which the fat in the meat may not be rendered. As such, it may be desirable to use temperatures no greater than about 210° F.

Embodiments of the invention are particularly useful for sausage, and any type of sausage for which the production includes a drying step may be used in embodiments of the invention, such as dry and semi-dry sausage. Examples of sliced or diced sausages which may be prepared using a drying process according to embodiments of the invention include pepperoni, sopressata, genoa salami, dry sausage, dry salami, jerky, lebannon bologna, summer sausage, chervalat, thuringer, goteberg, holsteiner, and sicilian salami. Other dried meats may also be dried as described herein. For example, dried meat such as beef jerky and bacon bits may be made using embodiments of the invention. Because of their high fat contents, these products may be heated in oil to remove their moisture without interfering with the taste or organoleptic properties of the sausages. Furthermore, water which is removed during drying may be replaced in part by fat, leading to an increased yield and therefore a more efficient and less expensive process. Generally, meats having a final fat content of at least 20% by weight and for which the production includes a drying step may be used in embodiments of the invention.

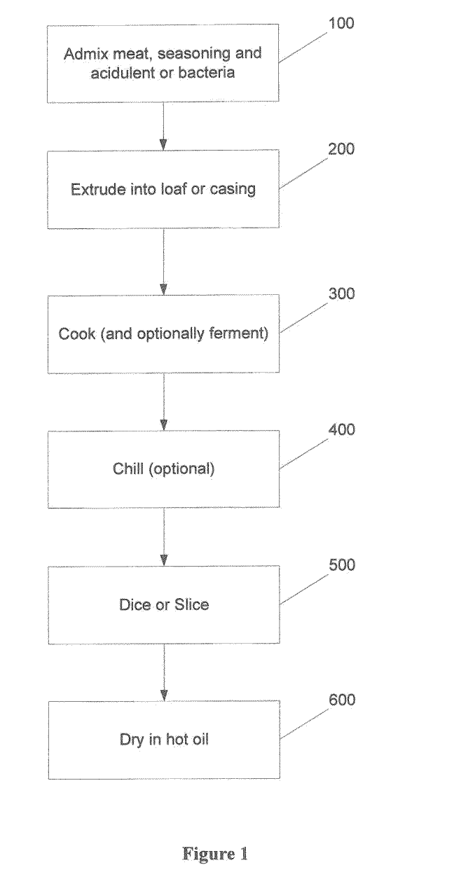

An example of a process for preparing dry or semi dry sausage according to embodiments of the invention is shown in FIG. 1. The first step is the admixing step 100. In this step, ground meat is admixed with seasoning and other optional ingredients. The meat and seasoning may be selected based upon the desired final sausage product. The meat may include one or more of pork, beef, poultry, chicken, turkey, deer, bison, or game birds and may be in a ground form. The seasoning may include garlic, red pepper, black pepper, anise, fennel, white pepper, liquid oleoresins of spices, ground mustard, salt, onion, dextrose and other seasonings. Nitrates and lactic acid starter culture may also be used for product flavor and color. Other ingredients which may be included are non-meat ingredients such as soy protein and whey protein. The admixing step 100 may be performed by a mixer, or other appropriate machinery or by hand mixing.

In some embodiments, an acidulant may be added at the admixing step 100. Examples of appropriate acidulants include citric acid, glutamine, glucono-delta-lactone, lactic acid, malic acid, sorbicacid, and acetic acid. In some embodiments, the acidulant includes a coating which melts to release the acidulant upon heating, such as coated citric acid. In other embodiments, an acid producing bacteria may be added to the meat mixture. Examples of such bacteria include Lactobacillus curvatus, Lactobacillus bavarious, Lactobacillus plantarum, and Lactobacillus sake.

The next step in the preparation process is the extrusion or stuffing step 200. In this step, the seasoned admixed meat is formed into shapes, such as links, loafs, dices, or crumbles. In some embodiments, the meat may be extruded into loafs, links, or other elongated shapes. In other embodiments, the meat may be extruded into casings which may be tied and/or separated at intervals to form links. The casing may be from an animal intestine or may be manufactured fibrous, porous casings.

The shaped meat is then fermented by acidification and cooked in the fermenting and cooking step 300. The steps of fermentation and cooking may be performed simultaneously, such as by placing the formed meat into a continuous oven. In embodiments including an acidulant, a fermentation step may not be required and this may be only a cooking step. However, if the acidulant is released upon heating, the cooking step will result in the release of the acidulant and the acidification of the meat, as would otherwise occur due to fermentation. The necessary cooking times and temperatures will depend upon the type of sausage being produced and upon the size of the sausage. In some embodiments, such as when the pH is less than about 5.0, the sausage may be cooked to a temperature of at least about 140° F. in order to meet the USDA pathogen control policy.

Alternatively, the fermenting and cooking step 300 may be separated into two different steps including a first fermenting step and a second cooking step. Such a process may be useful when acidification is provided by bacterial fermentation processes. In such embodiments, fermentation may by done first by resting at a controlled temperature, such as about 90° F. to about 110° F., and controlled humidity for a period of time. Cooking would then progress as described above with regard to the combined cooking and optional fermentation step 400.

In order to dry the meat quickly and efficiently in the oil bath, it is first reduced in size, such as by slicing or dicing into smaller pieces. In preparation for dicing or slicing the sausage, the cooked sausage may be chilled in an optional chilling step 400. This chilling step 400 can be done by batch or continuous chill systems, such as systems using ammonia refrigeration or cryogenics. The meat can be chilled to a temperature of from about 20° F. to about 40° F., for example. When the meat is chilled in this way, it can be easier to dice or slice and can result in smoother cuts in the meat. Alternatively, the cooked meat may be sliced or diced after cooking without first chilling the cooked meat.

Next, the meat may be reduced in size in an optional size reduction step 600. For example, the meat may be size reduced such as by chopping, or slicing, or dicing into small cubes, chunks, or similar pieces. Such small pieces may be useful as pizza toppings, for example. In some embodiments, the meat may be diced into pieces measuring about ½ inch or less in maximum dimension. For example, the meat may be diced into pieces, such as square or rectangular cubes, measuring approximately ⅛ inch to ½ inch in maximum dimension. Alternatively, the sausage may be sliced into disks or patties. Such slices or disks may be about ⅛ inch or less in thickness. In some embodiments, the slices or disks may be between about 1/16 and ¼ inch thick. In some embodiments, it may be useful to reduce the size of the meat in order to allow for more efficient heat transfer during the drying process by increasing the surface to volume ratio of the meat.

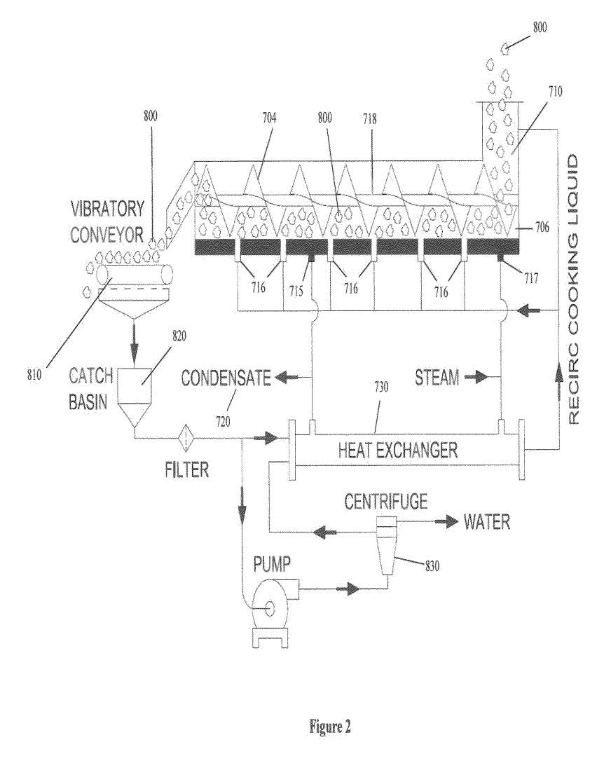

Drying step 600 may be performed by placing or immersing the prepared meat into hot oil. In some embodiments, the meat is transferred into an oil bath. In other embodiments, the meat is transferred into oil in a conveyor system, such as thermal screw. Examples of thermal screw which may be used in embodiments of the invention include CONTINUTHERM, available from Blentech. An example of a thermal screw which may be used in embodiments of the invention is shown in FIG. 2. In the example shown, thermal screw 700 includes an elongated horizontally oriented trough 702 with a rotating screw 704 extending from a proximal end 706 to a distal end 708 of the trough 702. An inlet 710 is shown at the proximal end for feeding meat pieces 800 into the trough 702 and an outlet 712 is shown at distal end 708 for removal of meat pieces 800 after passing along the length of the trough 702. As screw 704 turns, it moves meat pieces 800 and the oil 714 along the length of trough 702. Oil 714 recirculates from an oil outlet 715 near distal end 708 and back to the proximal end through an oil inlet 717 and during this recirculation condensate 720 is removed and the oil is heated back up to the desired temperature by a heat exchanger 730. Meat pieces 800 pass from outlet 712 to a belt 810, upon which they may be conveyed for further processing. Excess oil 714 may be removed from meat pieces 800 on belt 810 which may pass through a filter 820 and centrifuge 830 for removal of water and then may return to the recirculating oil system. Trough 702 may also include a plurality of jets 716 which may inject air bubbles or other gas into the bottom of trough 702 to agitate the meat pieces so that none become stuck on the bottom of the trough or remain on surface 718 of oil 714.

As the meat is heated in the oil, water is removed from the meat, and some of the water may be replaced by oil, thereby reducing the moisture to protein ratio. The amount of time for which the meat is heated in the oil will depend upon the temperature of the oil, the thickness of the product pieces, and the final desired moisture to protein ratio. For example, if the oil is at a temperature of from about 200° F. to about 230° F., product having a thickness of ¼ inch may be held in the oil for from about 3 minutes to about 4 minutes to obtain a final product having a moisture to protein ratio of about 1.4:1 to about 1.7:1. Alternatively, if the oil is at a temperature of from about 270° F. to about 340° F., the same product may be held in the oil for from about 15 seconds to about 30 seconds to obtain a final product having a moisture to protein ratio of from about 1.7:1 to about 1.09:1. In another alternative, if the oil is at a temperature of from about 200° F. and 230° F., product sliced at 3 mm of thickness may be held in the oil for from about 2 minutes to about 3 minutes to obtain a final product having a moisture to protein ratio of from about 1.5:1 to about 1.6:1.

The appropriate temperature may be chosen based upon the type of machinery or equipment in which the meat will be heated. For example, conveyor systems may have a certain minimum transit time for the meat, depending upon the size of the conveyor system. For example, in a standard screw conveyor having a oil bath measuring about 20 feet in length, the meat may take from about 2 minutes to about 4 minutes to pass through the system. The temperature must therefore be selected to provide the proper amount of moisture removal. Too high or too low of a temperature will result in the removal of too much or too little moisture, resulting in a product which may be undesirable or may not meet USDA standards. Alternatively, if a quicker drying process is desired, a conveyor system may be designed having a shorter oil bath. In such embodiments, the shortened path may allow the meat to pass more quickly through the system. In order to accommodate a quicker passage through the oil bath, the oil would be heated to a higher temperature in order to achieve the same moisture to protein ratio. Alternatively, the product may be cut into smaller pieces or thinner slices to achieve a quicker drying time.

The oil which is used in the thermal screw may be an animal or a vegetable oil, or a mixture or blend thereof. Any vegetable oil which may be heated to the desired temperatures without smoking or breaking down may be used, such as canola oil, soybean oil, palm oil, corn oil, sunflower oil, safflower oil, peanut oil, or a combination or blend of oils. Animal fats that may be used include pork lard and beef tallow. In some embodiments, a blend of animal and vegetable based fats may be used.

As water is removed from the meat, the water is released into the hot oil. Embodiments of the invention may remove this water from the oil. For example, the thermal screw may circulate oil to a filter and centrifuge which can remove water and meat particles from the oil, then the oil may recirculate to the thermal screw. It may also be desirable to agitate the meat while in the oil, so that the meat does not sink or float and is smoothly conveyed through the oil heating system. In some embodiments, a fluid such as water, air, gas or oil may be injected into the trough for more uniform heating of the meat.

It should be noted that the temperature of the oil may vary as it progresses through a conveyor system. For example, the hottest oil will be at the point of entry of the coldest products, and the temperature of the oil in the screw conveyor troughs may decrease by approximately 5° F.-15° F. as the oil travels from the inlet to the outlet. Oil temperatures disclosed herein therefore represent the average oil temperature to which the meat is exposed in the oil heating system.

After passing through the hot oil, and exiting the thermal screw, surface oil may be removed from the meat, such as by using an air knife and perforated vibration conveyor, for example.

The processes for removal of moisture from meat by immersion in hot oil can be used for drying other meats besides dry and semi dry sausage. For example, embodiments of the invention may be used for the drying of jerky, dried meat, or bacon bits. In such embodiments, the process to prepare the meat prior to drying can be accomplished according to known processes for meat production. However, instead of drying the meat by other methods, the meat may be dried by immersion in hot oil as described herein with regard to the drying of sausage.

It should also be noted that, as compared to conventional drying methods, drying meat using hot oil according to embodiments of the invention can result in an improved yield. Using conventional drying methods, water evaporates such that final weight of the product will be less than the starting weight by the amount of weight of the water lost. The loss of yield will therefore depend, in part, on the beginning water content and therefore on the quantity of water removed during drying. A meat having a higher water content will have a correspondingly higher decrease in product weight and therefore a lower yield. For example, a pepperoni product may have a yield of about 60-70%, when comparing the weight of the product before and after drying. In contrast, using the drying method according to embodiments of the invention, it is believed that, as the heated oil is exposed to the surface of the meat, the protein becomes denatured, allowing for water to be released from the meat and replaced, at least in part, by fat. This results in less loss of product weight, such that yield may be from about 65% to about 75% for pepperoni, for example.

The improvement in yield may also depend in part upon the fat content of the meat being dried. During the drying process according to embodiments of the invention, some fat may be lost due to rendering, depending upon the heating parameters. As such, a meat having a higher fat content may lose more fat due to rendering, resulting in less improvement in yield. In contrast, a leaner meat, which would lose less fat during the drying process, may have a greater improvement in yield.

In addition to providing an improved yield as compared to air drying methods, embodiments of the invention also dry the meat more quickly than air drying methods. For example, air drying methods may require slow drying to avoid hardening of the case which can trap moisture in the center of the meat. Even in air drying methods in which the size of the product is reduced prior to drying and which may use heated air in the drying process, the drying time is still substantially longer than when the product is dried in oil. This is because the oil used in the drying step provides a more efficient and direct transfer of heat to the product which allows the product to be dried to its core.

Although the method includes heating in oil, it should be understood that this is different from cooking meat by frying. Unlike typical meats which are fried for cooking, the meat used in embodiments of the invention has been acidulated or fermented prior to heating in oil. Also, the meat has been cooked prior to heating in oil, so that the control of pathogens and the setting of the proteins that normally occurs during frying has already occurred prior to heating the product in oil to dry it. In addition, frying temperatures are typically high in order to achieve browning. For example, a proper temperature range for frying can be 350° F. to 450° F., which is above the drying temperatures used in embodiments of the invention. See, for example, Deep Frying: Chemistry, Nutrition and Practical Application, Edited by Edward G. Perkins and Michael D. Erickson, AOCS Press, 1996.

### EXAMPLES

The pepperoni used in the drying experiments shown in Examples 1-3 were prepared in accordance with embodiments of the invention and included dicing/slicing and drying through heated oil.

For each example, a meat mix was prepared by first coarse grinding the meat (pork, chicken and beef) and then admixing the coarse ground meat with salt, seasoning, soy protein and dextrose. The meat included 75% pork, 20% chicken, and 5% beef. The fat content for the meat was targeted at 30 to 35% fat by weight of the meat.

Other ingredients in the pepperoni included seasonings which were a combination of natural spices and oil extractives, additional seasonings, dextrose and salt (used as carriers for the natural oil extractives), curing agent, and soy protein.

The pepperoni used in Examples 1 and 3 was prepared using fermentation. The meat mix described above was mixed with the other ingredients and a bacterial culture (Lactobacillus bavarious, Lactobacillus curvatus, and Lactobacillus sake) until the ingredients were distributed uniformly in the meat mix. The mixture was then chilled to 28° F. in a blast freezer, then final ground to ⅛ inch. A portion of the chilled meat mix was then placed in a Handtmann vacuum stuffer and filled into 48 mm fibrous casings prior to fermentation and cooking. The other portion of the chilled meat mix was extruded into 1 inch diameter round sticks without casings. The product was then fermented in an ALKAR batch cook house at 95° F.-100° F. until the pH dropped below 4.9. The product having a casing was hung for fermentation, while the product without casing was laid on screened shelves. The raw product was then chemically analyzed and the results are shown in Table 1, below.

TABLE 1

| Moisture | | | |
|---|---|---|---|
| (M) % | Fat % | Protein (P) % | Ratio M:P |
| 47.258 | 26.31 | 17.9 | 2.64 |

Acidified product was used for Example 2. The meat mix described above was mixed with the other ingredients until the ingredients were distributed uniformly in the meat mix. The mixture was then chilled to 28° F. in a blast freezer, then final ground to ⅛ inch. The mixture was then returned to the mixer and 0.75 to 1.0 percent of BALCHEM encapsulated organic acid was added and then mixed to insure uniformity. The organic acids consisted of a combination of acetic acid, lactic acid, and Glucono-Delta-Lactone (GDL). (The encapsulated acid was later released by the combined effects of heat and moisture during cooking.) A portion of the mixture including the encapsulated acid was then placed in a HANDTMANN vacuum stuffer and filled into 48 mm fibrous casings. The other portion of the chilled meat mix was extruded into sticks without casings measuring ¾ inch to 1.5 inch in diameter. The stuffed and extruded products were cooked using an ALKAR batch cook house with a computer controlled cooking step to allow uniform heating of the product and to insure that the pH dropped to below 4.9. Once the pH target was reached, the product was heated to 131° F. and held for one hour to meet USDA microbial lethality requirements. The cooked product was then chilled in air to 30° F. prior to dicing or slicing as needed for drying in heat oil, as described further below.

After preparation as described above, the pepperoni for each example was first diced or sliced and then placed into a heated oil bath at temperatures ranging from 200° F. to 340° F. for the times for drying as indicated in each of the examples below. A jacketed 75 gallon kettle containing soybean oil was used for drying the sliced or diced pepperoni. Prior to drying, the diced pepperoni was at a temperature of 25 to 28° F. and was weighed to obtain samples of either 100 grams or 200 grams. The samples were put into a perforated basket and lowered into the heated soybean oil in the kettle and were heated in the oil for a predetermined time and temperature. The samples were then removed from the oil and drained of excessive surface oil. They were next placed on pans and quick frozen for 30 minutes. Moisture content was measured as specified in AOAC:950.46. Protein content was measured as specified in AOAC:992.15 and AACC:46-30. Fat was measured by gas chromatography according to AOAC:996.06 which was modified to use hydrogen as the carrier gas rather than helium as specified in the standard.

### Example 1

The fermented and cooked pepperoni was chilled to 25 to 28° F. and diced into particles measuring ¼ inch by ¼ inch and then heated as described above for the time and temperatures shown in Table 2, below. Each sample was analyzed for moisture, protein, fat and moisture to protein ratio and the results are shown in Table 3.

TABLE 2
Fermented and Cooked Pepperoni with Soy Protein

| | | | Starting | End (dry) | | |
|---|---|---|---|---|---|---|
| | Temp | Time | Weight | Weight | % | % |
| Sample | F. ° | m:s | (g) | (g) | Remaining | Loss |
| 1 | 204 | 3:00 | 100 | 69.4 | 69.4% | 30.60 |
| 2 | 215 | 3:30 | 200 | 128.5 | 64.3% | 35.75 |
| 3 | 220 | 3:30 | 200 | 127.5 | 63.8% | 36.25 |
| 4 | 222 | 4:00 | 200 | 123 | 61.5% | 38.50 |
| 5 | 224 | 4:00 | 200 | 125 | 62.5% | 37.50 |
| 6 | 230 | 4:00 | 200 | 125 | 62.5% | 37.50 |
| 7 | 211 | 3:00 | 200 | 122.4 | 61.2% | 39% |
| 8 | 215.9 | 3:00 | 200 | 122.6 | 61.3% | 39% |
| 9 | 217.9 | 3:30 | 200 | 122.3 | 61.2% | 39% |
| 10 | 216.3 | 3:45 | 200 | 125.1 | 62.6% | 37% |
| 11 | 219.1 | 3:30 | 200 | 125.3 | 62.7% | 37% |
| 12 | 211.5 | 3:30 | 200 | 123.1 | 61.6% | 38% |
| 13 | 213.3 | 3:00 | 200 | 140.5 | 70.3% | 30% |
| 14 | 218.3 | 3:30 | 200 | 138.6 | 69.3% | 31% |
| 15 | 216 | 4:00 | 200 | 140 | 70.0% | 30% |
| 16 | 217.9 | 3:30 | 200 | 139.5 | 69.8% | 30% |

TABLE 3
Chemical Analysis of Fermented and
Cooked Pepperoni from Table 2

| | Temp | Time | Moisture | Fat | Protein | Ratio |
|---|---|---|---|---|---|---|
| Sample | F. ° | m:s | (M) % | % | (P) % | M:P |
| 1 | 204 | 3:00 | 39.28 | 28.12 | 24.9 | 1.58 |
| 2 | 215 | 3:30 | 39.64 | 27.42 | 24.4 | 1.62 |
| 3 | 220 | 3:30 | 39.56 | 28.35 | 23.8 | 1.66 |
| 4 | 222 | 4:00 | 35.32 | 31.82 | 26 | 1.36 |
| 5 | 224 | 4:00 | 40.57 | 27.65 | 25.2 | 1.61 |
| 6 | 230 | 4:00 | 36.53 | 30.47 | 25.2 | 1.45 |
| 7 | 211 | 3:00 | 38.25 | 31.02 | 23.5 | 1.63 |
| 8 | 215.9 | 3:00 | 38.18 | 31.38 | 23.3 | 1.64 |
| 9 | 217.9 | 3:30 | 37.59 | 32.33 | 23.6 | 1.59 |
| 10 | 216.3 | 3:45 | 34.76 | 32.81 | 24.2 | 1.44 |
| 11 | 219.1 | 3:30 | 38.47 | 31.16 | 24 | 1.60 |
| 12 | 211.5 | 3:30 | 39.44 | 29.01 | 24 | 1.64 |
| 13 | 213.3 | 3:00 | 37.85 | 32.01 | 23.2 | 1.63 |
| 14 | 218.3 | 3:30 | 37.74 | 32.23 | 22.6 | 1.67 |
| 15 | 216 | 4:00 | 37.62 | 32.39 | 22.9 | 1.64 |
| 16 | 217.9 | 3:30 | 39.12 | 230.5 | 23.8 | 1.64 |

### Example 2

In example 2, stuffed and extruded product was prepared as described above. For samples 17 and 18, the pepperoni was chilled to 25 to 27° F. and diced into particles measuring ¼ inch by ¼ inch by ¼ inch. For samples 19 and 20, it was chilled to 25 to 27° F. and sliced such that the slices measured 12.7 mm in diameter and ⅛ inch in thickness. The samples were heated in oil as described above for the time and temperature shown in Table 4. Yield is also shown in Table 3. The results of chemical analysis of moisture, fat, protein, and moisture to protein ratio are shown in Table 5. These results indicate that increased yield was obtained by drying the meat in hot oil.

TABLE 4
Acidified and Cooked Pepperoni with Soy Protein

| | Temp | Time | Starting | End (dry) | % | % |
|---|---|---|---|---|---|---|
| Sample | Deg F. | m:s | Weight/g | Weight/g | Remaining | Loss |
| 17 | 215.7 | 3:30 | 200 | 132.60 | 66.3% | 34% |
| 18 | 217 | 3:30 | 200 | 134.00 | 67.0% | 33% |
| 19 | 215.9 | 2:30 | 173.30 | 132.90 | 76.7% | 23% |
| 20 | 219 | 3:00 | 182.70 | 133.30 | 73.0% | 27% |

TABLE 5
Chemical Analysis for Acidified and
Cooked Pepperoni with Soy Protein

| | Temp | Time | Moisture | Fat | Protein | Ratio |
|---|---|---|---|---|---|---|
| Sample | F. ° | m:s | % | % | % | M:P |
| 17 | 215.7 | 3:30 | 39.44 | 29.01 | 24.00 | 1.64 |
| 18 | 217 | 3:30 | 38.59 | 29.64 | 24.50 | 1.58 |
| 19 | 215.9 | 2:30 | 37.75 | 27.43 | 24.3 | 1.55 |
| 20 | 219 | 3:00 | 37.41 | 28.52 | 24.8 | 1.51 |

### Example 3

After fermenting and cooking, pepperoni was chilled in a high velocity freezer to a temperature of 25° F.-28° F. and then diced into cubes measuring ¼ inch by ¼ inch by ¼ inch. The samples were prepared and heated in oil as described above for the times and temperatures shown in Table 6, below. The weight before and after heating in the oil and the final product weight and moisture to protein ratio for each sample is shown in Table 6. The samples are grouped into sets of three having the same approximate time and temperature and an average result for each group is also shown in Table 6.

TABLE 6

| Test | Temp (F.°) | Time (sec) | Weight in | Weight out | M:P ratio |
|---|---|---|---|---|---|
| 21 | 279 | 15 | 100.93 | 76.29 | |
| 22 | 279 | 15 | 102.63 | 78.88 | |
| 23 | 279 | 15 | 115.8 | 85.46 | |
| | | Average | 106.45 | 80.21 | 1.7:1 |
| | | | Yield | 75.35 | |
| 24 | 279 | 30 | 100.54 | 66.03 | |
| 25 | 279 | 30 | 100.11 | 66.35 | |
| 26 | 279 | 30 | 101.02 | 65.66 | |
| | | Average | 100.56 | 66.01 | 1.28:1 |
| | | | Yield | 65.65 | |
| 27 | 304 | 15 | 100.12 | 67.62 | |
| 28 | 290 | 15 | 100.14 | 70.94 | |
| 29 | 290 | 15 | 100.72 | 73.99 | |
| | | Average | 100.33 | 70.85 | 1.53:1 |
| | | | Yield | 70.62 | |
| 30 | 290 | 30 | 102.97 | 67.38 | |
| 31 | 290 | 30 | 107.69 | 69.59 | |
| 32 | 290 | 30 | 105.64 | 68.84 | |
| | | Average | 105.43 | 68.60 | 1.2:1 |
| | | | Yield | 65.07 | |
| 33 | 340 | 15 | 104.70 | 63.18 | |
| 34 | 330 | 15 | 109.25 | 71.54 | |
| 35 | 330 | 15 | 102.48 | 67.43 | |
| | | Average | 105.48 | 67.38 | 1.09:1 |
| | | | Yield | 63.88 | |

These examples show that methods of making semi-dry and dry sausages as described herein resulted in satisfactory samples, having reduced moisture to protein ratios. The examples further show that the time of oil immersion and the temperature of the oil, can be adjusted to obtain a desired moisture to protein ratio for the dry and semi-dry sausage.

In the foregoing detailed description, the invention has been described with reference to specific embodiments. However, it may be appreciated that various modifications and changes can be made without departing from the scope of the invention as set forth in the appended claims. Thus, some of the features of preferred embodiments described herein are not necessarily included in preferred embodiments of the invention which are intended for alternative uses.

1. A method of preparing a semi-dry or dry sausage comprising:
mixing raw ground meat and seasoning to form seasoned ground meat;
extruding the seasoned ground meat into a formed shape or into a casing;
cooking the extruded meat;
dicing or slicing the extruded meat; and
immersing the cooked diced or sliced meat in oil at a time and temperature sufficient to remove moisture from the cooked meat to form a semi-dry or dry sausage.

2. The method of claim 1 wherein the step of immersing the cooked meat in oil is performed at a temperature of between about 200 and 300 degrees Fahrenheit.

3. The method of claim 1 wherein the step of immersing the cooked meat is performed using a thermal screw.

4. The method of claim 1 wherein after immersing the cooked meat in oil, the dried meat has a moisture to protein ratio of approximately 1.6 to 1 or less.

5. The method of claim 1 further comprising fermenting the extruded meat prior to cooking the meat.

6. The method of claim 1 wherein the seasoned ground meat is combined with an acidulant.

7. The method of claim 1 wherein the cooked meat is immersed in the oil for less than 4 minutes.

8. The method of claim 1 wherein the cooked meat is immersed in the oil for less than 1 minute.

9. The method of claim 1 wherein the semi-dry or dry sausage is pepperoni.

10. The method of claim 1 further comprising removing the dry or semi-dry sausage from the oil.

11. A method of reducing the drying time of a cooked semi-dry or dry sausage comprising:
cutting cooked sausage into pieces having a reduced size;
transferring the cut cooked sausage into a trough of thermal screw, wherein the trough contains oil at a temperature between 200 and 300 degrees Fahrenheit;
passing the cut sausage through the trough to dry the cut sausage; and
removing the dried sausage from the heated oil.

12. The method of claim 11 wherein cutting comprises slicing or dicing.

13. The method of claim 11 wherein the dried sausage has a moisture to protein ratio of approximately 1.6 to 1 or less.

14. The method of claim 11 wherein the step of passing the cut sausage through the trough to dry the cut sausage is performed for less than 4 minutes.

15. The method of claim 11 wherein the step of passing the cut sausage through the trough is performed for less than 1 minute.

16. A method of improving yield of semi-dry or dry sausage after drying comprising:
cutting cooked sausage having a first weight into pieces having a reduced size;
transferring the cut cooked sausage into heated oil at a temperature between 200 and 300 degrees Fahrenheit;
immersing the cooked sausage in the heated oil for a period of time sufficient to dry the sausage to a moisture to protein ratio of 1.6 to 1 or less; and
removing the dried sausage from the heated oil, wherein the dried sausage has a second weight which is less than the first weight;
wherein a ratio of the second weight to the first weight is about 60 to about 76 percent.

17. The method of claim 16 wherein cutting comprises slicing or dicing.

18. The method of claim 16 wherein the dried sausage has a moisture to protein ratio of approximately 1.6 to 1 or less.

19. The method of claim 16 wherein the step of passing the cut sausage through the trough to dry the cut sausage is performed for less than 4 minutes.

20. The method of claim 16 wherein the step of passing the cut sausage through the trough is performed for less than 1 minute.
